(19) United States
(12) Patent Application Publication
(10) Pub. No.: US 2011/0310431 A1
(43) Pub. Date: Dec. 22, 2011

(54) IMAGE PROCESSING APPARATUS, CONTROL METHOD THEREOF, AND PROGRAM

(75) Inventor: Hiroshi Uchikawa, Yokohama-shi (JP)

(73) Assignee: CANON KABUSHIKI KAISHA, Tokyo (JP)

(21) Appl. No.: 13/153,556

(22) Filed: Jun. 6, 2011

(30) Foreign Application Priority Data
Jun. 18, 2010 (JP) 2010-139944

(51) Int. Cl. G06F 15/00

(52) U.S. Cl. 358/1.15

(57) ABSTRACT

An image processing apparatus includes a window manager which switches an operation screen to be displayed on a display unit and a Web browser which displays an operation screen of an external application on the display unit together with a “return” button used to allow a transition to an operation screen previously displayed on the display unit. The Web browser manages history information indicating a display history on the display unit since an operation screen of an internal application which was displayed on the display unit before that operation screen was switched to the operation screen of the external application. Furthermore, when the “return” button is pressed, and a transition destination of the operation screen is the operation screen of the internal application, the Web browser notifies the window manager of a screen switch request required to display the operation screen of the internal application on the display unit.

### BACKGROUND OF THE INVENTION

1. Field of the Invention

The present invention relates to an information processing system which includes a server apparatus, an image processing apparatus that can use external applications provided by the server apparatus, a control method, and a program.

2. Description of the Related Art

An existing multifunction peripheral (MFP) incorporates a Web browser and often implements, for example, scan and print applications which are accomplished by cooperation between server applications and the MFP through a Web server access. In such operation mode, applications need not be installed in each individual MFP, and need only be installed in the Web server, thus providing a great advantage in terms of cost. Such operation mode will become more popular as MFPs gain more advanced functions.

In this use case, the user operates Web applications customized to fit a customer environment at a destination using a Web browser, and user's operations are basically completed on the Web browser. However, since general functions which need not be customized use native applications incorporated in advance in the MFP, some users may demand to use both the Web applications and native applications. In this case, it becomes important to seamlessly realize operations on the Web browser and those with the native applications in terms of operability. For example, Japanese Patent Laid-Open No. 2002-207766 has made a proposal that improves operability upon re-displaying a Web page which has been accessed once on a Web browser.

However, the related art suffers the following problems. In the related art, when the user wants to return from a Web application operation screen to an operation screen unique to the MFP, even when he or she presses a return key laid out on the Web application operation screen, the screen cannot be returned to the operation screen unique to the MFP. In this way, since the related art cannot realize a seamless transition between the Web application operation screen and native application operation screen, an operation system provides poor usability for the user.

### SUMMARY OF THE INVENTION

The present invention enables realization of an image processing apparatus and control method thereof, which can provide integrated operability between external and internal applications to improve user usability.

One aspect of the present invention provides an image processing apparatus, which allows for the use of an external application held in an external apparatus and an internal application held in a self apparatus, the apparatus comprising: a screen management unit that switches an operation screen to be displayed on a display unit according to a screen switch request; and a control unit that displays an operation screen of the external application on the display unit together with a first button used to allow a transition to an operation screen previously displayed on the display unit, the control unit comprising: a history management unit that manages history information indicating a display history on the display unit since an operation screen of the internal application which was displayed on the display unit before that operation screen was switched to an operation screen of the external application by the screen management unit; a determination unit that determines, when the first button is pressed, with reference to the history information managed by the history management unit whether or not a transition destination of the operation screen is the operation screen of the internal application; and a notification unit that notifies, when the determination unit determines that the transition destination is the operation screen of the internal application, the screen management unit of the screen switch request required to display the operation screen of the internal application on the display unit.

Further features of the present invention will be apparent from the following description of exemplary embodiments with reference to the attached drawings.

### BRIEF DESCRIPTION OF THE DRAWINGS

FIG. 1 is a diagram showing an example of the arrangement of an image processing system 100 including an image processing apparatus 101 according to the first embodiment;

FIG. 2 is a block diagram showing an example of the hardware arrangement of the image processing apparatus 101 according to the first embodiment;

FIG. 3 is a block diagram showing an example of the software configuration of the image processing apparatus 101 according to the first embodiment;

FIG. 4 is a sequence chart showing a window registration processing at activation timing according to the first embodiment;

FIG. 5 shows a window management information stored in an HDD 204 by a window manager 309 according to the first and second embodiments;

FIG. 6 is a sequence chart showing a window switching processing according to the first embodiment;

FIG. 7 is a view showing superimposed windows according to the first embodiment;

FIG. 8 is a flowchart showing the processing sequence of a Web browser 311 according to the first embodiment;

FIG. 9 is a view showing screen transitions according to the first embodiment;

FIG. 10 is a view showing an access history state according to the first embodiment;

FIG. 11 is a view showing an initial application setting screen according to the second embodiment;

FIG. 12 is a sequence chart showing window registration processing at activation timing according to the second embodiment;

FIG. 13 is a sequence chart showing window switching processing according to the second embodiment;

FIG. 14 is a view showing superimposed windows according to the second embodiment;

FIG. 15 is a flowchart showing the processing sequence of a Web browser 311 according to the second embodiment;

FIG. 16 is a view showing screen transitions according to the second embodiment;

FIG. 17 is a view showing the state of an instruction assigned to the “home” button according to the second embodiment;

FIG. 18 is a view showing an operation unit 212 of the image processing apparatus 101 according to the first embodiment; and

FIG. 19 is a view showing an example of operation flows.

### DESCRIPTION OF THE EMBODIMENTS

Embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

### Arrangement of Image Processing System

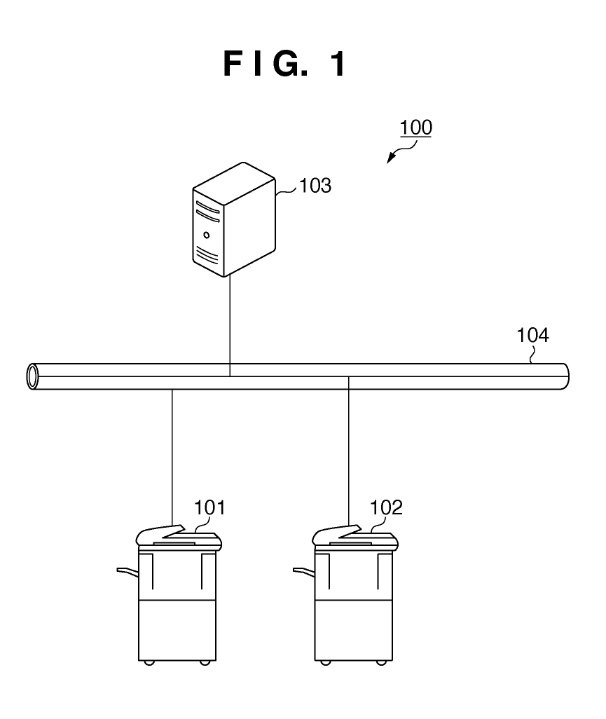

The first embodiment according to the present invention will be described hereinafter. This embodiment will explain an operation when the “return” button (first button) is pressed on an operation screen of a Web browser. An image processing system 100 including an image processing apparatus according to the present invention will be described first with reference to FIG. 1. As shown in FIG. 1, the image processing system 100 is configured to include image processing apparatuses 101 and 102, and a PC (personal computer) 103, which are connected on a network.

The image processing apparatus 101 is a multifunction peripheral (MFP), which has not only a function of copying a paper document, but also a function of printing print data output from an external printer driver, and a function of sending image data obtained by scanning a paper document to an external file server or a mail address (SEND function). Furthermore, the image processing apparatus 101 also has a function of sending data to another image processing apparatus 102 and controlling the destination image processing apparatus to print that data (remote copy function, FAX function), and a function of displaying various Web pages by accessing the PC 103 (to be described below).

The PC 103 is a server apparatus, that is, a Web server, which returns HTML data that configures a Web page in response to a Web page acquisition request from the image processing apparatus 101. This embodiment will exemplify the image processing system 100 in which the image processing apparatuses 101 and 102 and the PC 103 are connected via an Ethernet® 104. However, the present invention is not limited to such specific systems. For example, the image processing system 100 may be configured by the image processing apparatus 101 alone by incorporating a Web server function of the PC 103 in the image processing apparatus 101. In this embodiment, the image processing apparatus 101 can use Web applications (external applications) held in the PC 103 in addition to native applications (internal applications) held in the apparatus itself.

### Hardware Arrangement of Image Processing Apparatus

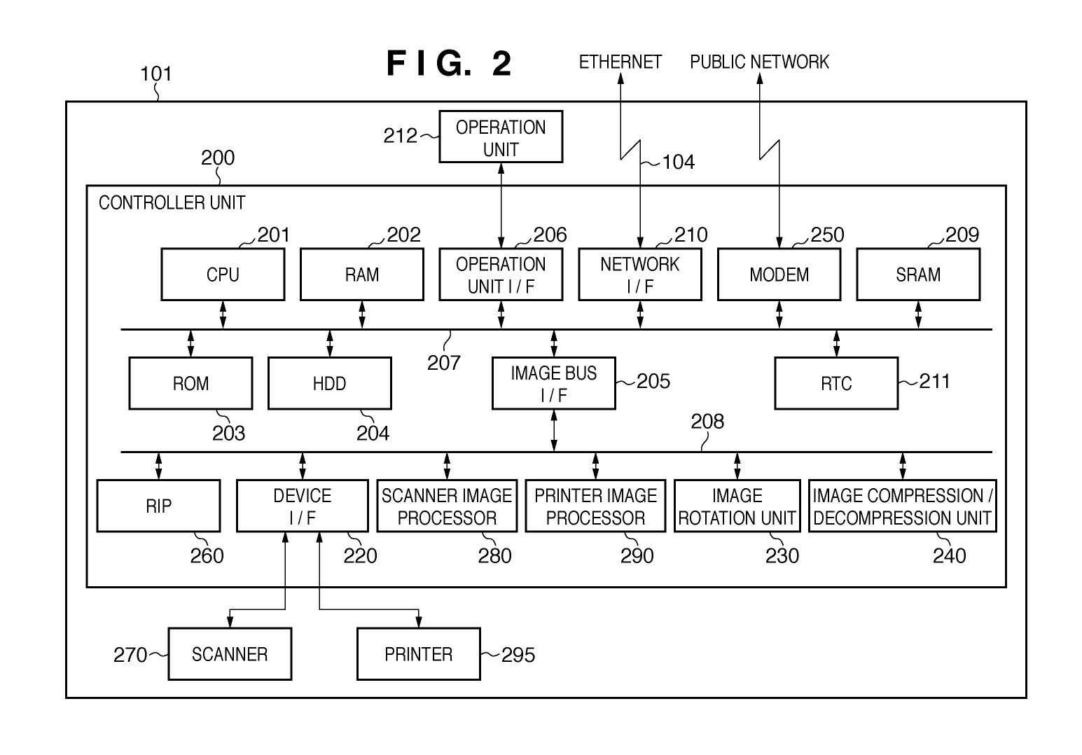

An example of the hardware arrangement of the image processing apparatus 101 will be described below with reference to FIG. 2. The image processing apparatus 101 includes a controller unit 200, scanner 270, printer 295, and operation unit 212. The controller unit 200 connects the scanner 270 as an image input device and the printer 295 as an image output device, and also the Ethernet® 104 and a public network, thus inputting/outputting image information and device information.

The controller unit 200 includes a CPU 201, RAM 202, ROM 203, HDD 204, image bus I/F 205, operation unit I/F 206, network I/F 210, modem 250, SRAM 209, and RTC 211. Furthermore, the controller unit 200 includes an RIP 260, device I/F 220, scanner image processor 280, printer image processor 290, image rotation unit 230, and image compression/decompression unit 240.

The CPU 201 is a controller which controls the image processing apparatus 101. The RAM 202 is a system work memory required for the operation of the CPU 201, and is also an image memory used to temporarily store image data. The ROM 203 is a boot ROM, and stores the boot program of a system. The HDD 204 is a hard disk drive, and stores, for example, system software, applications, and image data.

The operation unit I/F 206 is an interface unit with the operation unit 212 having a touch panel, and outputs image data to be displayed on a display unit of the operation unit 212 to the operation unit 212. Also, the operation unit I/F 206 transfers information input by the user of the image processing system 100 from the operation unit 212 to the CPU 201. The network I/F 210 is connected to the Ethernet® 104, and inputs/outputs information. The modem 250 is connected to the public network to input/output information.

The SRAM 209 is a nonvolatile storage medium that allows high-speed operations. The RTC 211 is a real-time clock, which executes processing for keeping count of the current time even when the controller unit 200 is in power-OFF state. The aforementioned devices are allocated on a system bus 207.

The image bus I/F 205 is a bus bridge, which connects the system bus 207 and an image bus 208 that transfers image data at high speed, and converts data formats. The image bus 208 is configured by a PCI bus or IEEE1394. On the image bus 208, the following devices are allocated.

The RIP 260 is a raster image processor, which rasterizes PDL code data into bitmap image data. The device I/F 220 connects the scanner 270 and printer 295 as image input and output devices to the controller unit 200, and converts synchronous/asynchronous systems of the image data. The scanner image processor 280 applies correction, modification, and edit processes to the inputted image data. The printer image processor 290 applies, for example, printer correction and resolution conversion to print output image data. The image rotation unit 230 rotates the image data. The image compression/decompression unit 240 executes compression/decompression processing of the image data.

### Operation Unit

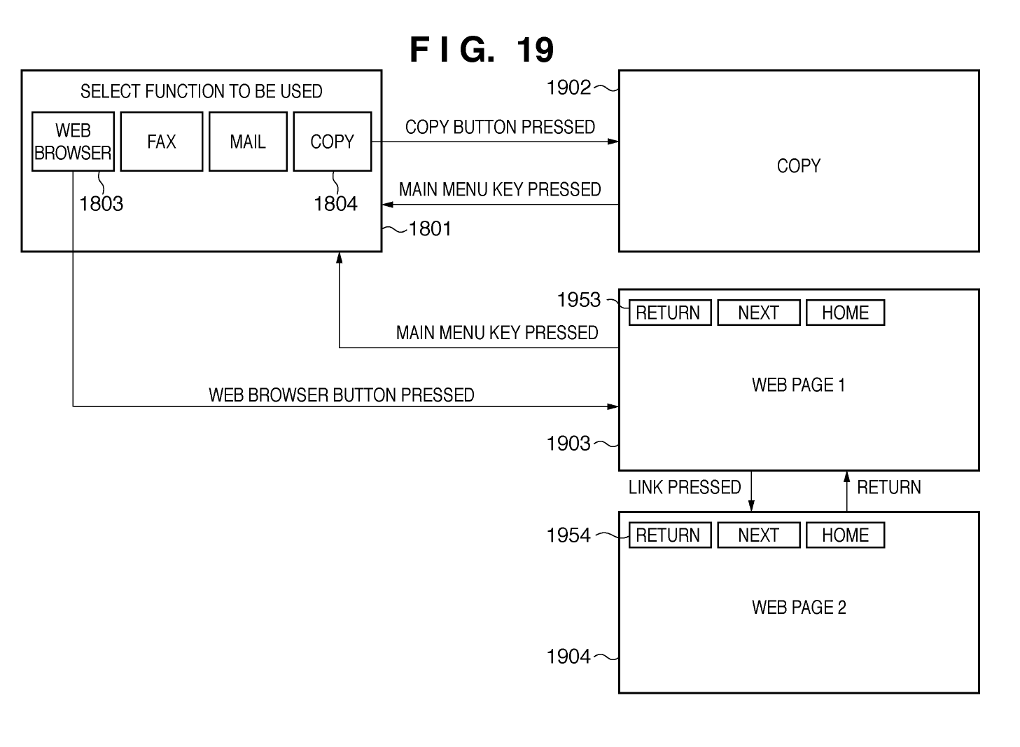

The operation unit 212 will be described below with reference to FIGS. 18 and 19. FIG. 18 shows an example of the operation unit 212. FIG. 19 shows an example of operation flows. In FIG. 18, reference numeral 1801 denotes a main menu screen displayed on the display unit of the operation unit 212. As described above, the display unit of the operation unit 212 includes a liquid crystal panel of a touch panel type, and allows the user to select software keys displayed on the screen, for example, a Web browser button 1803 and copy button 1804. Upon pressing of the Web browser button 1803, a Web browser screen 1903 of an external application provided by the PC 103 is displayed. On the other hand, upon pressing of the copy button 1804, a copy screen 1902 of a copy function as a native application held in advance in the image processing apparatus 101 is displayed. Reference numeral 1802 denotes a main menu button of hardware keys arranged on the operation unit 212. Upon pressing of the main menu button 1802, the currently displayed screen (for example, the copy screen 1902 or Web browser screen 1903) transits to the main menu screen 1801.

A Web browser includes a “return” button as a general user interface. The “return” button is popularly recognized by users, and is frequently used to return to a screen previously operated by the user. Therefore, the “return” button is desirable for users who are familiar with Web browsers not only to allow screen transitions on the Web browser but also to allow them to return to the previous screen, for example, a screen unique to the image processing apparatus 101.

However, the conventional “return” button only allows the user to select a Web page accessed by a Web browser. More specifically, when the user selects a “return” button 1954 on a Web browser screen 1904 shown in FIG. 19, it is possible to return to the Web browser screen 1903. On the other hand, when the user selects a “return” button 1953 on the Web browser screen 1903, the button 1953 itself cannot be selected since there is no return destination. That is, even when the user repetitively selects the “return” buttons on the respective pages, he or she can only reach a Web page that was accessed first but he or she cannot reach the main menu screen 1801 as an origin of the operations. Hence, this embodiment realizes a mechanism required to return to an operation screen as an origin of operations (the main menu screen 1801 in this embodiment) when the user selects the “return” button 1953 of the Web browser screen 1903, so as to improve operability.

### Software Configuration of Image Processing Apparatus

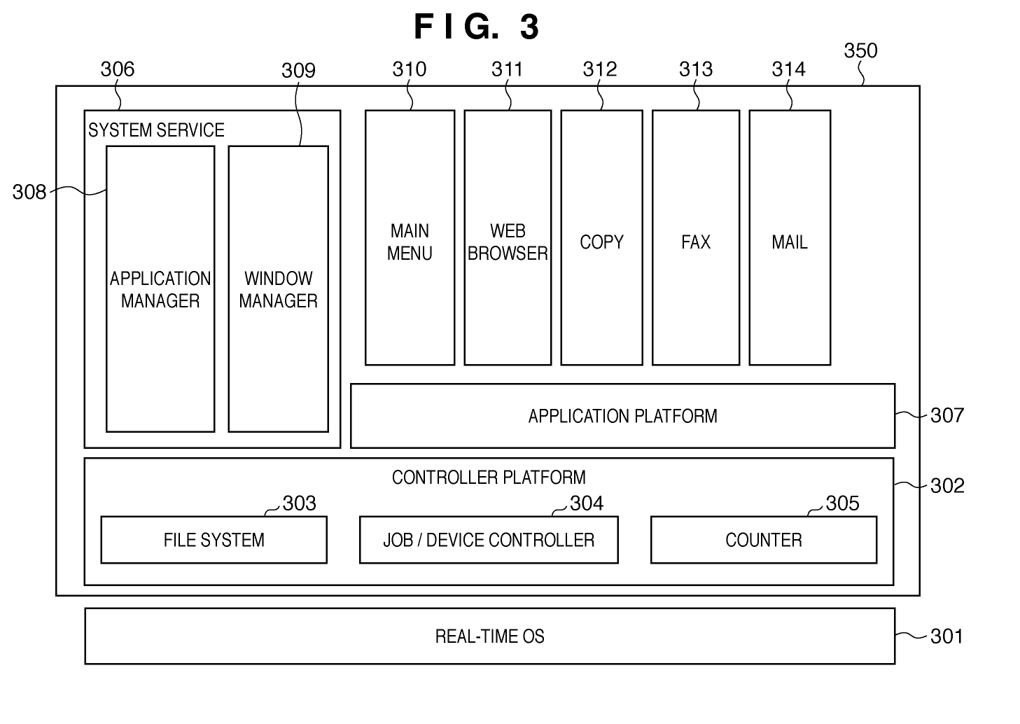

An example of the software configuration of the image processing apparatus 101 will be described below with reference to FIG. 3. The software configuration to be described below is stored in the HDD 204 of the image processing apparatus 101 as so-called firmware 350, which is read out onto the RAM 202 and is executed by the CPU 201.

A real-time OS 301 is a real-time operating system, which provides various resource management services and frameworks optimized to control an embedded system to software programs which run on the OS 301. Various resource management services and frameworks provided by the real-time OS 301 include multi-task (thread) management which substantially attains parallel operations of a plurality of processes by managing a plurality of execution contexts of the processes by the CPU 201, and inter-task communications which realize synchronization and data exchange between tasks. Furthermore, such services and frameworks include memory management, interrupt management, various device drivers, and protocol stacks which implement processes of various protocols for a local interface, network, and communications.

A controller platform 302 includes a file system 303, job/device controller 304, and counter 305. The file system 303 is a mechanism which is built on a storage device such as the HDD 204 or RAM 202 and is required to store data. The job/device controller 304 controls hardware of the image processing apparatus 101, and controls jobs that use basic functions (for example, print, scan, communication, and image conversion functions) mainly provided by hardware of the image processing apparatus 101. The counter 305 manages validity dates of respective applications, and print and scan counter values, which are stored in the SRAM 209.

The system service 306 includes an application manager 308 and window manager 309. The application manager 308 is a management module required to install, uninstall, launch, and quit, for example, applications 310, 311, 312, 313, and 314. The window manager 309 manages operation screens of the applications 310, 311, 312, 313, and 314, and switches the operation screen to be displayed on the display unit in accordance with a screen switch request from each application.

An application platform 307 is a middleware which allows the applications 310, 311, 312, 313, and 314 to use the mechanisms of the real-time OS 301 and controller platform 302. The applications 310, 311, 312, 313, and 314 are application software programs which implement various business models using functions provided by the application platform 307. The main menu 310 has a menu function that allows the user to select an application. The Web browser 311 has a Web browser function that allows the user to browse a Web server. More specifically, the Web browser 311 displays an operation screen of an external application on the display unit, and allows the external application to run. The copy 312 has a copy function for copying a paper document. The FAX 313 has a FAX function for sending data. The mail 314 has a function of sending data as a mail message.

### Window Registration Processing

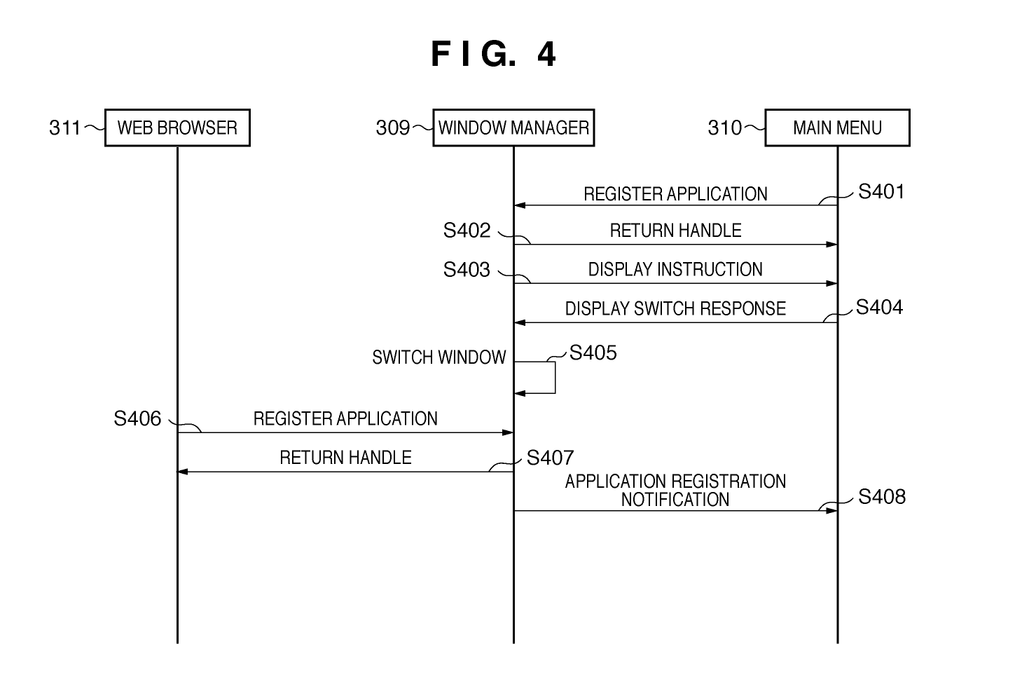

Window registration processing at an activation timing of the image processing apparatus 101 according to this embodiment will be described below with reference to FIGS. 4, 5, and 7. The firmware 350 associated with window management of this embodiment is stored in the HDD 204 of the image processing apparatus 101, is read out onto the RAM 202, and is executed by the CPU 201.

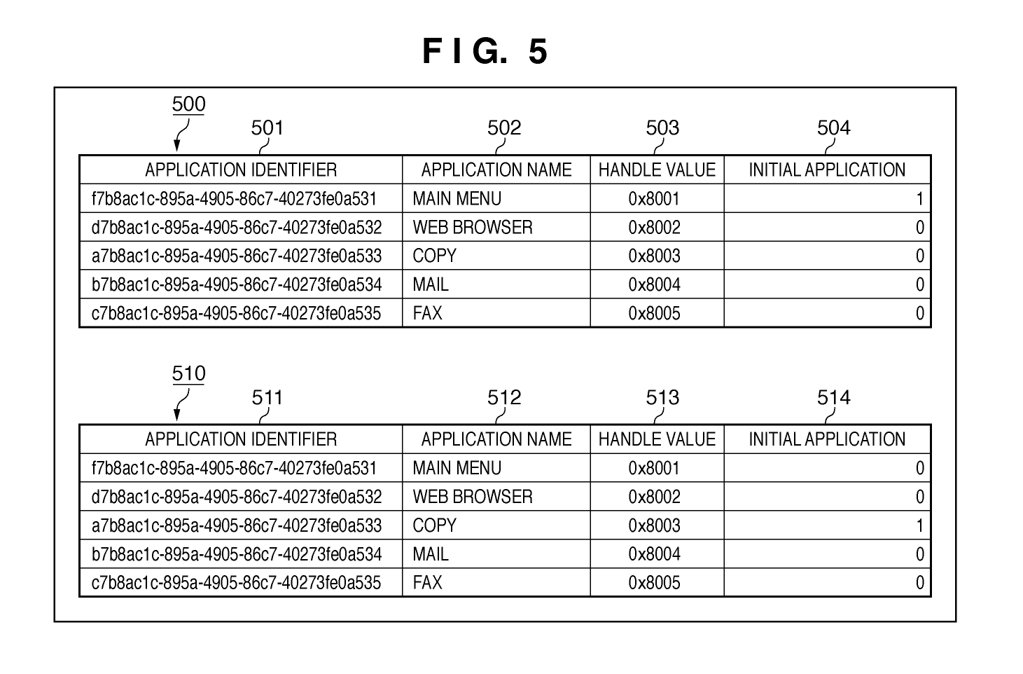

In FIG. 5, reference numeral 500 denotes window management information stored in the HDD 204 by the window manager 309 according to this embodiment. An application identifier 501 is an identifier (UUID: Universal Unique IDentifier) unique to an application which holds a window. An application name 502 is a name of an application which holds a window. A handle value 503 is a unique identification information newly assigned by the window manager 309 for each reception of an application registration request (corresponding to processes in steps S401 and S406 to be described later). Therefore, the window management information 500 includes information of each application which notified the window manager 309 of a registration request. That is, each application managed in the window management information 500 is active. The handle values 503 are used when windows are controlled between the window manager 309 and applications such as the main menu 310 and Web browser 311. An initial application 504 is information which represents whether or not an application of interest is an application to be displayed as an initial application. The initial application is information indicating an application which is displayed at the activation timing of the image processing apparatus 101 or when the image processing apparatus 101 is not used for a predetermined period, and only one initial application is set. If this information is “1”, it represents that the application of interest is set as the initial application. Note that hereinafter, when an operation screen is set as the initial screen of the initial application it will be referred to as a basic screen.

When the image processing apparatus 101 is activated, the main menu 310 executes an application registration processing to the window manager 309 in step S401 in FIG. 4. Information to be registered includes the application identifier 501 and application name 502 of the window management information 500. In step S402, the window manager 309 assigns a handle value 503 unique to that application, records the handle value 503 in the window management information 500, and returns that handle value 503 to the main menu 310. Then, the window manager 309 checks whether or not the application identifier registered in step S401 is set as the initial application 504. As shown in FIG. 5, in the window management information 500, the main menu is set as the initial application. Therefore, in step S403, the window manager 309 issues a display instruction to the main menu 310.

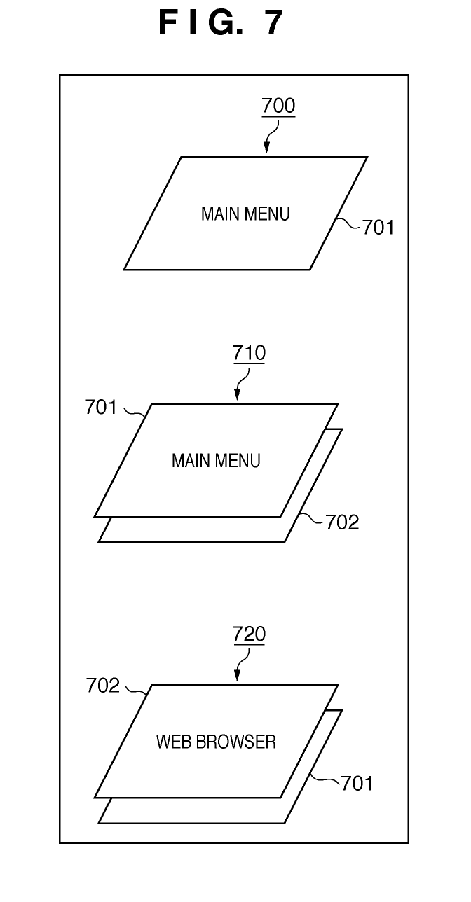

Upon reception of the display instruction, the main menu 310 executes processing required to display a screen, and then returns a display switch response to the window manager 309 in step S404. Upon reception of the display switch response, the window manager 309 displays a window of the main menu 310 in step S405. For example, in this case, a screen indicating that activation of the image processing apparatus 101 is in progress is switched to a main menu screen as an initial screen (basic screen). Also, as an order of windows at this timing, only a main menu 701 is laid out, as denoted by reference numeral 700 in FIG. 7. FIG. 7 shows windows managed by the window manager 309.

In step S406, the Web browser 311 executes application registration processing to the window manager 309. Upon reception of an application registration request, the window manager 309 assigns a handle value 503 unique to that application, records the handle value 503 in the window management information 500, and returns that handle value 503 to the Web browser 311 in step S407.

In step S408, the window manager 309 notifies the main menu 310 of the handle value 503 of the registered Web browser 311 as an application registration notification. As an order of windows at this timing, the main menu 701 is laid out as a foreground window and a Web browser 702 is laid out at a position below the foreground window, as denoted by reference numeral 710 in FIG. 7.

### Window Switching Processing

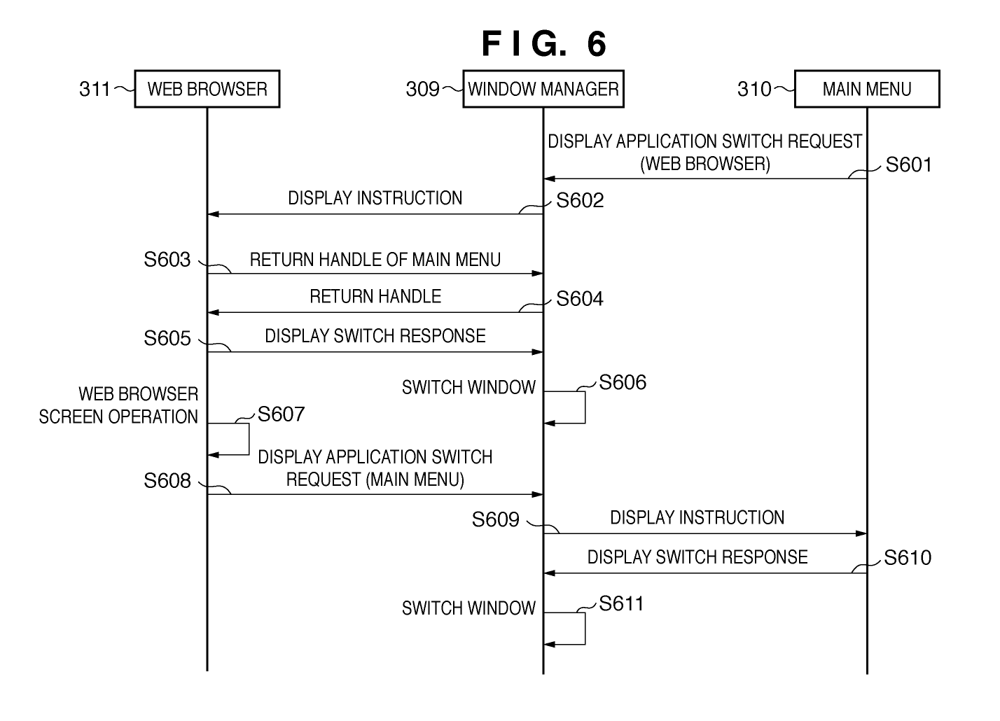

Window switching processing according to this embodiment will be described below with reference to FIG. 6. The firmware 350 associated with window management of this embodiment is stored in the HDD 204 of the image processing apparatus 101, is read out onto the RAM 202, and is executed by the CPU 201. The following description will be given taking, as an example, switching of operation screens when the user launches the Web browser 311 from the main menu 310, and wants to return an operation screen from the Web browser 311 to the main menu 310 again.

When the user presses the Web browser button 1803 on the main menu screen 1801 shown in FIG. 18, the main menu 310 issues a display application switch request (screen switch request) to the window manager 309 with designating the handle value of the Web browser 311 in step S601. In step S602, the window manager 309 issues a display instruction to the Web browser 311. Upon reception of the display instruction, the Web browser 311 issues a handle acquisition request of the main menu 310 to the window manager 309 in step S603. In step S604, the window manager 309 returns the handle value of the main menu 310 to the Web browser 311.

The Web browser 311 executes processing required to display a screen, and then returns a display switch response to the window manager 309 in step S605. Upon reception of the display switch response, the window manager 309 displays a window of the Web browser 311 in step S606. As an order of windows at this timing, the Web browser 702 is laid out as a foreground window, and the main menu 701 is laid out at a position below the foreground window, as denoted by reference numeral 720 in FIG. 7. With the processing executed so far, the user can display various Web pages by operating the Web browser in step S607.

When the user wants to switch the application from the Web browser 311 to the main menu 310, for example, when he or she presses the “return” button 1953 on the Web browser screen 1903, the Web browser 311 issues a display application switch request to the window manager 309 with designating the handle value of the main menu 310 in step S608. In step S609, the window manager 309 issues a display instruction to the main menu 310. Upon reception of the display instruction, the main menu 310 executes the processing required to display a screen, and then returns a display switch response to the window manager 309 in step S610. Upon reception of the display switch response, the window manager 309 displays a window of the main menu 310 in step S611. As an order of windows at this timing, the main menu 701 is laid out as a foreground window, and the Web browser 702 is laid out at a position below the foreground window, as denoted by reference numeral 710.

### Processing of Web Browser

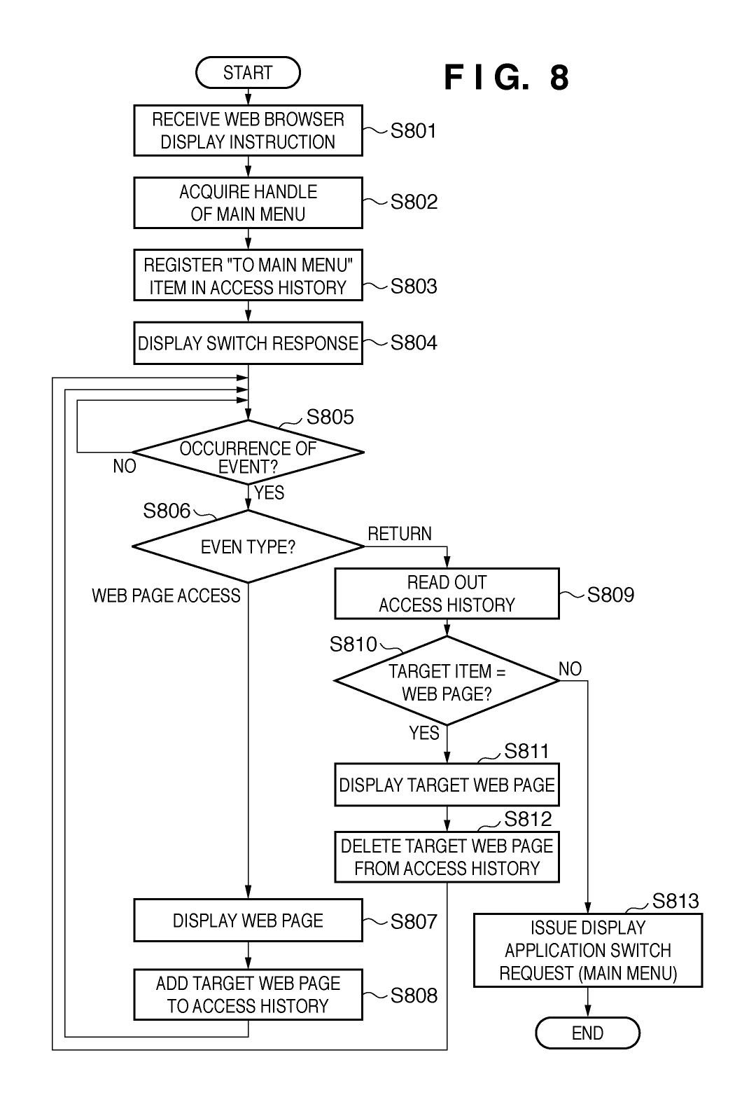

The processing sequence of the Web browser 311, that is, processing as a characteristic feature of this embodiment will be described below with reference to FIG. 8. The Web browser 311 of this embodiment is stored in the HDD 204 of the image processing apparatus 101 as the firmware 350, which is read out onto the RAM 202 and is executed by the CPU 201.

In step S801, the Web browser 311 receives a Web browser display instruction (corresponding to step S602). In step S802, the Web browser 311 acquires the handle value of the main menu 310 (corresponding to steps S603 and S604). After that, the Web browser 311 creates a “to main menu” item in an access history to be stored in a memory such as the RAM 202 in step S803, returns a display switch response (corresponding to step S605) in step S804, and waits for an event in step S805.

If an event has occurred, the process advances to step S806, and the Web browser 311 confirms a type of the event. In this case, the process in step S806 is an example of a history management unit. If the event is a Web page access, the process advances to step S807, and the Web browser 311 displays a Web page. In step S808, the Web browser 311 adds a target Web page in the access history, and the process returns to step S805.

On the other hand, if the type of the event is pressing of the “return” button in step S806, the process advances to step S809, and the Web browser 311 reads out the access history. The Web browser 311 checks in step S810 whether or not a target item is a Web page. If the target item is the Web page, the process advances to step S811, and the Web browser 311 displays the Web page designated by the access history. In step S812, the Web browser 311 deletes the target Web page from the access history, and the process returns to step S805. On the other hand, if the target item is not a Web page, the process advances to step S813, and the Web browser 311 notifies the window manager 309 of a display application switch request with designating the handle value of the main menu 310 acquired in step S802 (corresponding to step S608), thus ending the processing.

### Screen Transition

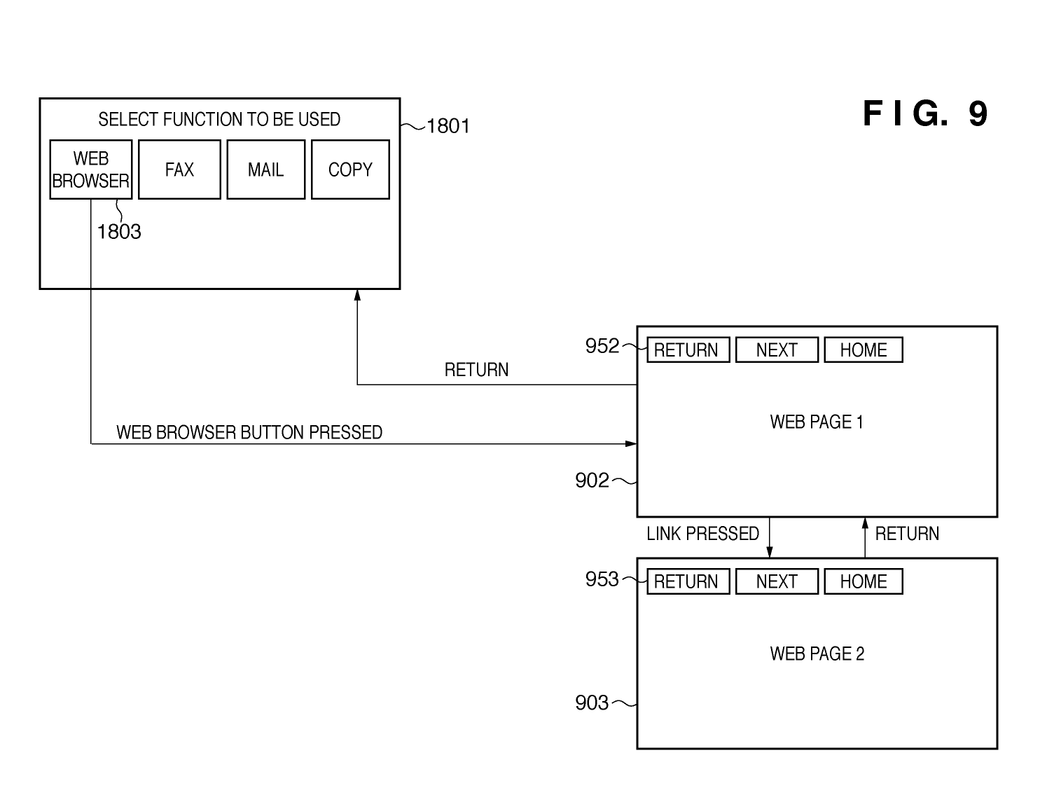

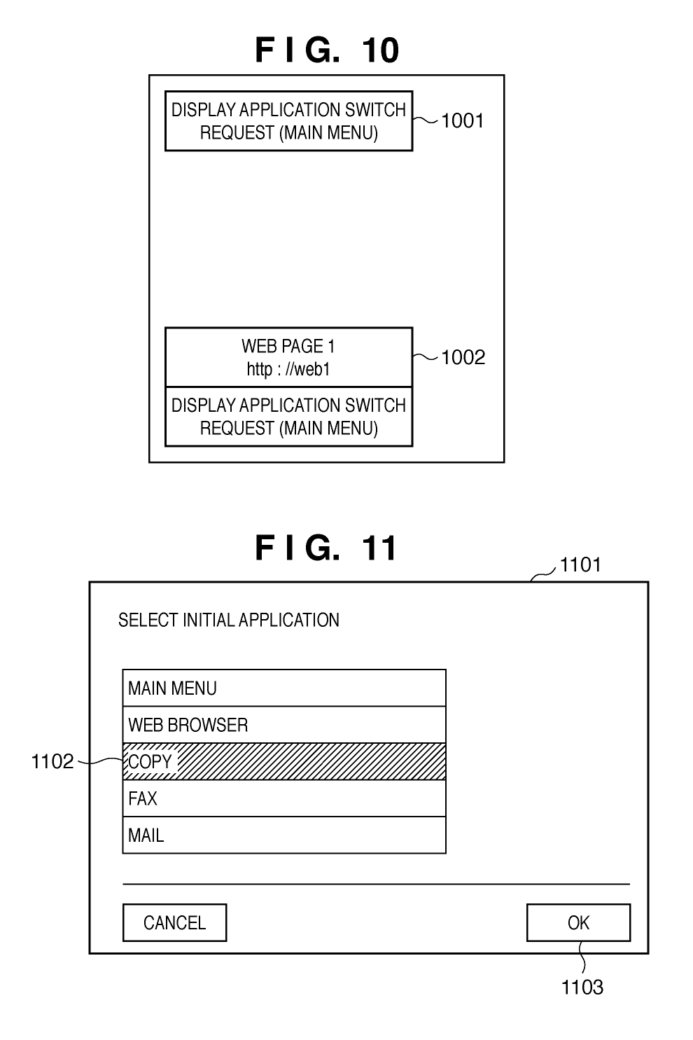

Screen transitions according to this embodiment will be described below with reference to FIGS. 9 and 10. As shown in FIG. 9, when the user presses the Web browser button 1803 on the main menu screen 1801, the main menu screen transits to a Web browser screen 902 to display Web page 1. In this state, a selection candidate of a “return” button 952 is configured like history information 1001 shown in FIG. 10.

More specifically, the history information 1001 indicates a display history of operation screens previously displayed on the operation unit (display unit) 212 of the image processing apparatus 101. When the Web browser 311 according to this embodiment is launched, it manages the history information. When the user presses the “return” button arranged on an operation screen of an external application, the Web browser 311 switches display to the previously displayed operation screen using the history information.

When the user presses a link (not shown) to Web page 2 included in Web page 1, the Web browser screen 902 transits to a Web browser screen 903 to display Web page 2. In this state, selection candidates of a “return” button 953 are configured like history information 1002. In this case, when the user presses the “return” button 953, the Web browser 311 reads out an access history in the information 1002, and transits to the Web browser screen 902. When the user successively presses the “return” button 952, the Web browser 311 reads out a window switch instruction to the main menu screen 1801 in the information 1001, thus allowing to return to the main menu screen 1801.

As described above, the image processing apparatus according to this embodiment includes the window manager 309 which switches an operation screen to be displayed on the display unit in accordance with a screen switch request. Furthermore, this image processing apparatus includes the Web browser 311 which displays an operation screen of an external application on the display unit together with a “return” button required to transit to an operation screen previously displayed on the display unit. The Web browser 311 manages history information indicating a display history on the display unit since an operation screen of a native application displayed on the display unit before switching to the operation screen of the external application. Furthermore, when the user presses the “return” button, and a transition destination of the operation screen is the operation screen of the native application, the Web browser 311 notifies the window manager 309 of a screen switch request required to display the operation screen of the native application on the display unit. Then, this image processing apparatus allows a transition from the screen of the Web browser to the operation screen of the native application as the previous screen in response to an operation on the Web browser. Hence, this image processing apparatus can provide integrated operability between the external and native applications, thus improving user usability.

### Second Embodiment

The second embodiment according to the present invention will be described hereinafter. This embodiment will explain an operation when the user presses the “home” button (second button) on an operation screen on a Web browser. More specifically, in this embodiment, when the user presses the “home” button, a transition is made to an operation screen (basic screen) of an application set as an initial application. This embodiment can be carried out in combination with the first embodiment. Note that the basic arrangement of this embodiment is the same as that of the first embodiment explained using FIGS. 1 to 3. Only the technique and arrangement as characteristic features of this embodiment will be described below, and a description redundant to that of the above embodiment will not be given.

### Setting of Initial Application

FIG. 11 shows an initial application setting screen 1101 according to this embodiment. A window manager 309 outputs the initial application setting screen 1101 to an operation unit 212. The window manager 309 is stored in an HDD 204 of an image processing apparatus 101 as firmware 350, which is read out onto a RAM 202 and is executed by a CPU 201.

As shown in FIG. 11, the initial application setting screen 1101 displays a list of applications registered in the window manager 309. When the user selects an application and presses the OK button 1103 on this screen, the selected application is set as the initial application. In the example shown in FIG. 11, when the user selects a copy 1102 and presses the OK button 1103, information of a main menu of the initial application is set to be “0”, and information of the copy is set to be “1”. As shown in FIG. 11, as the initial application, a Web browser 311 required to run an external application can also be selected. As a result, setting information in window management information 500 shown in FIG. 5 is changed to that in window management information 510.

### Window Registration Processing

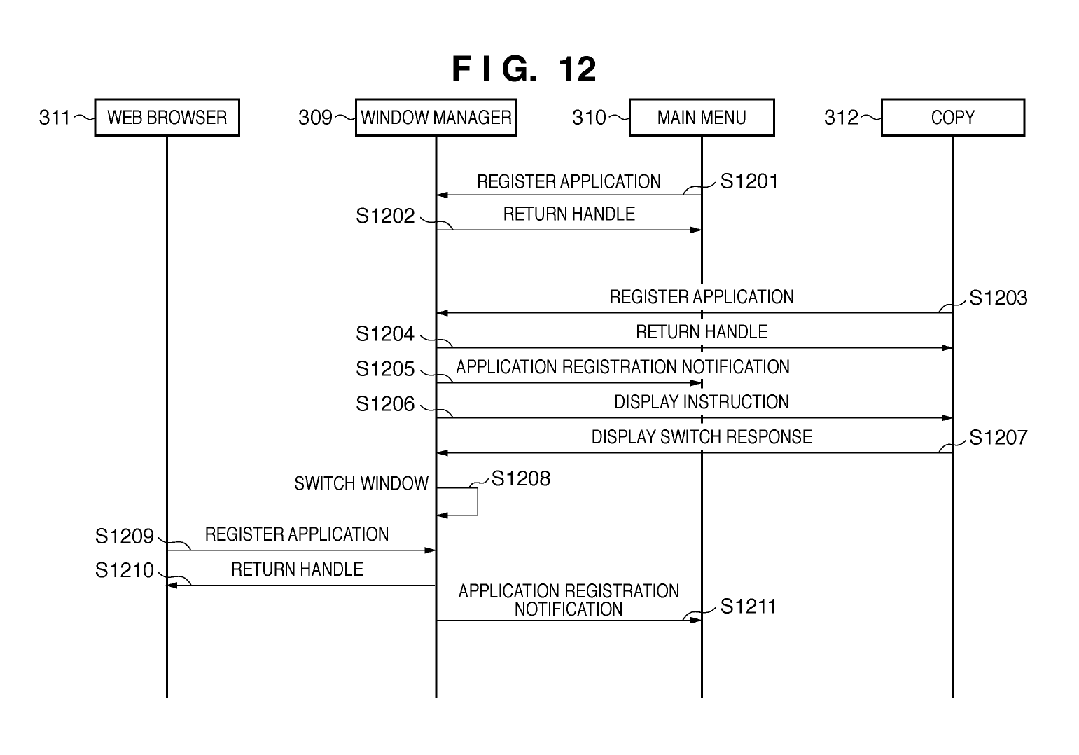

Window registration processing at an activation timing of the image processing apparatus 101 according to this embodiment will be described below with reference to FIG. 12. The firmware 350 associated with window management of this embodiment is stored in the HDD 204 of the image processing apparatus 101, is read out onto the RAM 202, and is executed by the CPU 201.

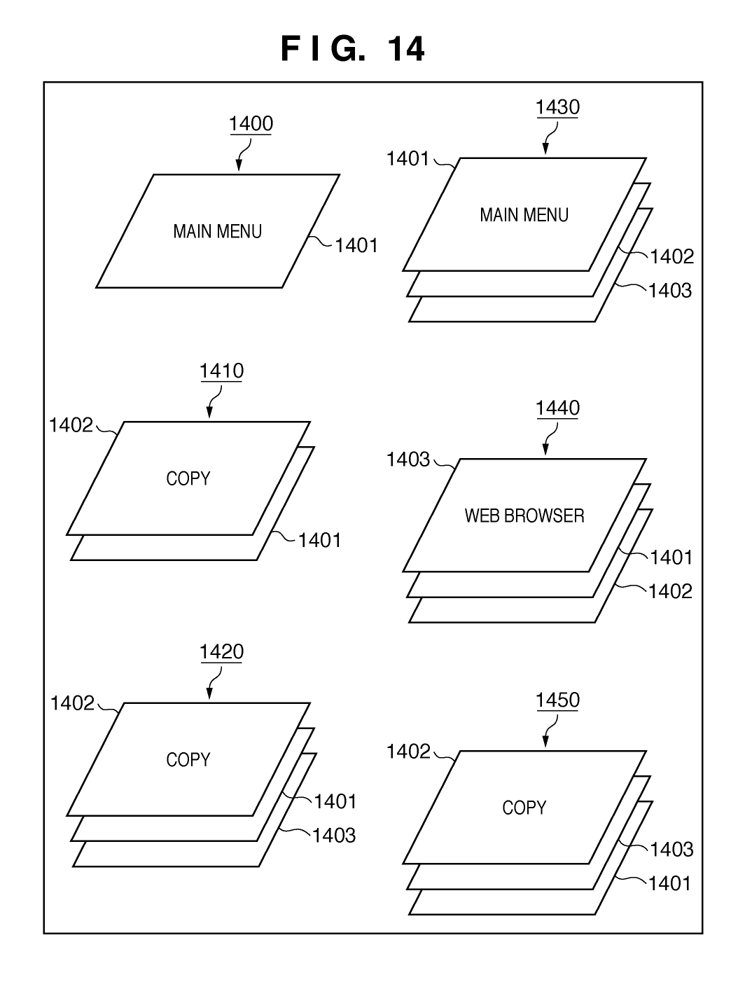

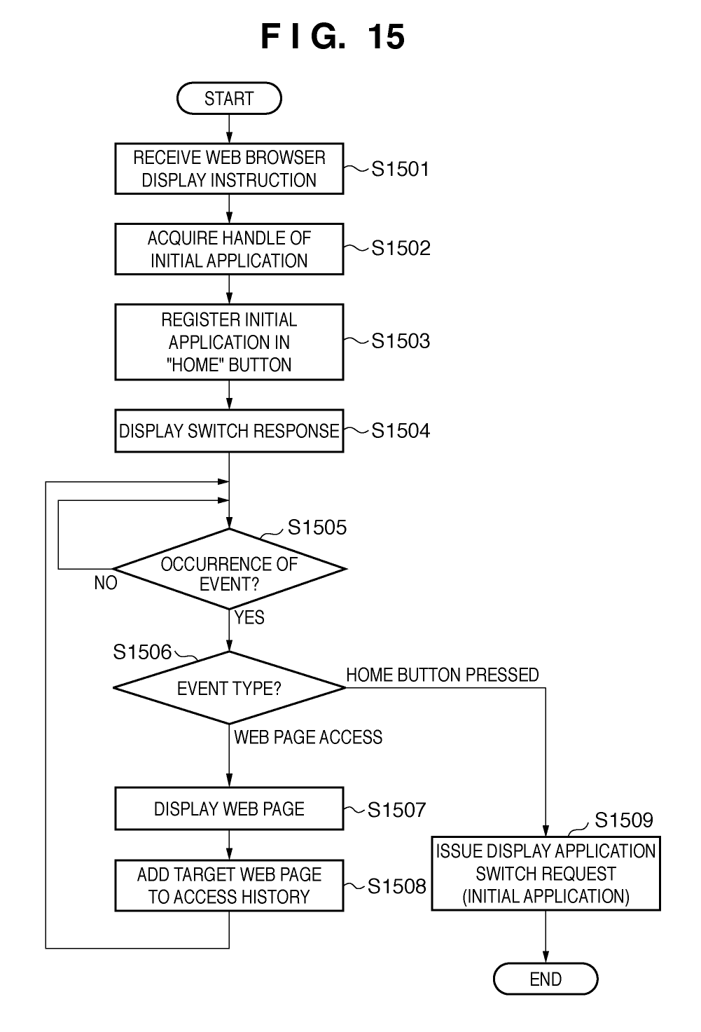

When the image processing apparatus 101 is activated, a main menu 310 executes application registration processing to the window manager 309 in step S1201. The window management information 510 includes, as information to be registered, an application identifier 511 and application name 512. Upon reception of an application registration request, the window manager 309 assigns a handle value 513 unique to that application, records the handle value 513 in the window management information 510, and returns that handle value 513 to the main menu 310 in step S1202. The window manager 309 checks whether or not the application identifier registered in step S1201 is set as an initial application 514. In this case, since the main menu is not set as the initial application in the window management information 510, the window manager 309 does not issue any display instruction to the main menu 310. As an order of windows at this timing, a main menu 1401 alone is laid out, as denoted by reference numeral 1400 in FIG. 14.

In step S1203, a copy 312 executes application registration processing to the window manager 309. Upon reception of an application registration request, the window manager 309 assigns a handle value 513 unique to that application, records the handle value 513 in the window management information 510, and returns that handle value 513 to the copy 312 in step S1204. Subsequently, the window manager 309 notifies the main menu 310 of the handle value of the registered copy 312 as an application registration notification in step S1205.

Next, the window manager 309 checks whether or not the application identifier registered in step S1204 is set as the initial application 514 in the window management information 510. Since the copy is set as the initial application in the window management information 510, the window manager 309 issues a display instruction to the copy 312 in step S1206. Upon reception of the display instruction, the copy 312 executes processing required to display a screen, and then returns a display switch response to the window manager 309 in step S1207. Upon reception of this response, the window manager 309 displays a window of the copy 312 in step S1208. As an order of windows at this timing, a copy 1402 is laid out as a foreground window, and the main menu 1401 is laid out at a position below the foreground window, as denoted by reference numeral 1410 in FIG. 14.

In step S1209, the Web browser 311 executes application registration processing to the window manager 309. Upon reception of an application registration request, the window manager 309 assigns a handle value 513 unique to that application, records the handle value 513 in the window management information 510, and returns that handle value 513 to the Web browser 311 in step S1210.

In step S1211, the window manager 309 notifies the main menu 310 of the handle value of the registered Web browser 311 as an application registration notification. As an order of windows at this timing, the copy 1402 is laid out as a foreground window, the main menu 1401 is laid out at a position below the foreground window, and a Web browser 1403 is laid out at a position below the window of the main menu 1401, as denoted by reference numeral 1420 in FIG. 14.

### Window Switching Processing

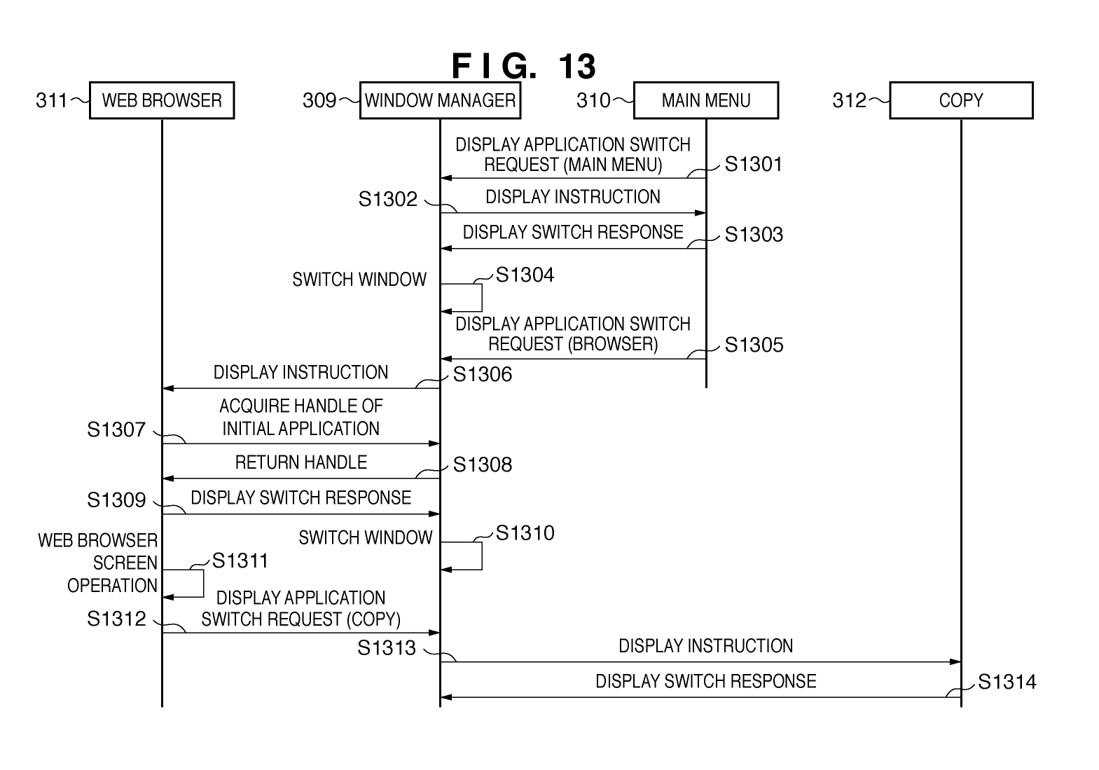

Window switching processing according to this embodiment will be described below with reference to FIG. 13. The firmware 350 associated with window management of this embodiment is stored in the HDD 204 of the image processing apparatus 101, is read out onto the RAM 202, and is executed by the CPU 201.

When the user presses a main menu key (not shown) on the currently displayed copy screen, the main menu 310 issues a display application switch request to the window manager 309 with designating the handle value of itself in step S1301. In step S1302, the window manager 309 issues a display instruction to the main menu 310. Upon reception of the display instruction, the main menu 310 executes processing required to display a screen, and then returns a display switch response to the window manager 309 in step S1303. Upon reception of the display switch response, the window manager 309 displays a window of the main menu 310 in step S1304. That is, in this case, the copy screen is switched to a main menu screen 1801. As an order of windows at this timing, the main menu 1401 is laid out as a foreground window, the copy 1402 is laid out at a position below the foreground window, and the Web browser 1403 is laid out at a position below the window of the copy 1402, as denoted by reference numeral 1430 in FIG. 14.

Furthermore, when the user presses a Web browser button 1803 on the main menu screen 1801, the main menu 310 issues a display application switch request to the window manager 309 with designating the handle value of the Web browser 311 in step S1305. The window manager 309 issues a display instruction to the Web browser 311 in step S1306. Upon reception of the display instruction, the Web browser 311 issues a handle acquisition request of the initial application to the window manager 309 in step S1307.

In step S1308, the window manager 309 returns the handle value of the copy 312. The Web browser 311 executes processing required to display a screen, and then returns a display switch response to the window manager 309 in step S1309. Upon reception of the display switch response, the window manager 309 displays a window of the Web browser 311 in step S1310. As an order of windows at this timing, the Web browser 1403 is laid out as a foreground window, the main menu 1401 is laid out at a position below the foreground window, and the copy 1402 is laid out at a position below the window of the main menu 1401, as denoted by reference numeral 1440 in FIG. 14. With the processing executed so far, the user can display various Web pages by operating the Web browser in step S1311.

When the user wants to switch the application from the Web browser 311 to the copy 312, the Web browser 311 issues a display application switch request to the window manager 309 with designating the handle value of the copy 312 in step S1312. The window manager 309 issues a display instruction to the copy 312 in step S1313. Upon reception of the display instruction, the copy 312 executes processing required to display a screen, and then returns a display switch response to the window manager 309 in step S1314. Upon reception of the display switch response, the window manager 309 displays a window of the copy 312 in step S1315. As an order of windows at this timing, the copy 1402 is laid out as a foreground window, the Web browser 1403 is laid out at a position below the foreground window, and the main menu 1401 is laid out at a position below the window of the Web browser 1403, as denoted by reference numeral 1450 in FIG. 14.

### Processing of Web Browser

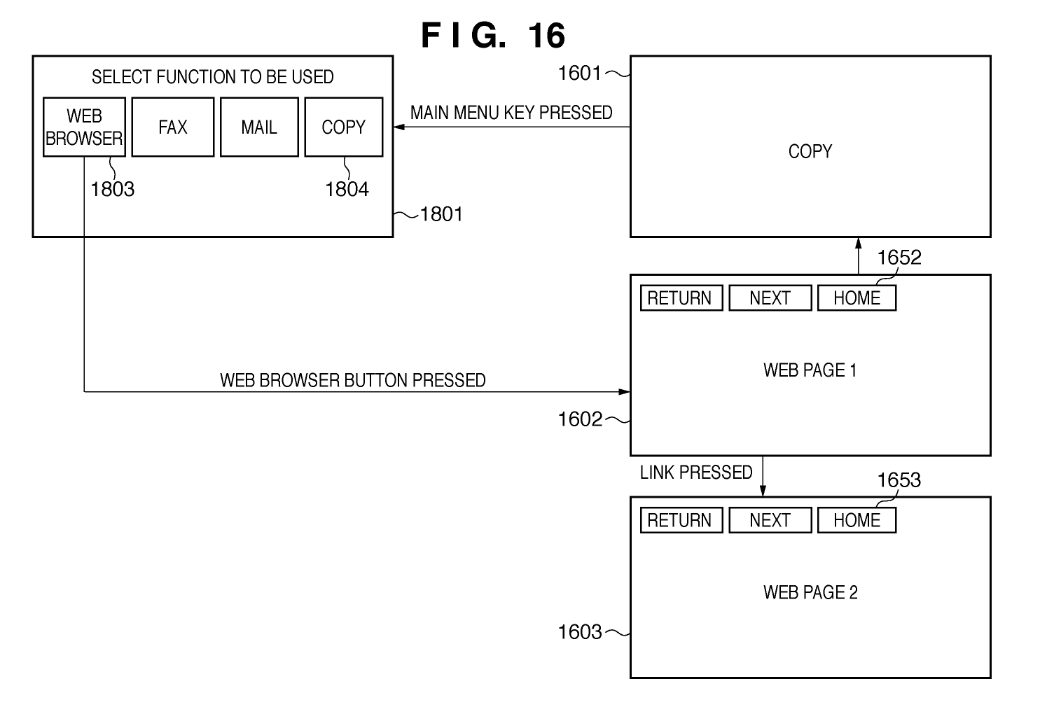

The processing sequence of the Web browser 311, that is, processing as a characteristic feature of this embodiment will be described below with reference to FIG. 16. The Web browser 311 of this embodiment is stored in the HDD 204 of the image processing apparatus 101 as the firmware 350, which is read out onto the RAM 202 and is executed by the CPU 201.

In step S1501, the Web browser 311 receives a Web browser display instruction (corresponding to step S1306). Then, in step S1502 the Web browser 311 acquires the handle value of the copy 312 (corresponding to steps S1307 and S1308). After that, the Web browser 311 registers a switch request to the initial application in the “home” button in step S1503, returns a display switch response (corresponding to step S1309) in step S1504, and waits for an event in step S1505.

If an event has occurred, the process advances to step S1506, and the Web browser 311 confirms a type of the event. If the event is a Web page access, the process advances to step S1507, and the Web browser 311 displays a Web page. In step S1508, the Web browser 311 adds a target Web page to an access history, and the process then returns to step S1505.

On the other hand, if the type of the event is pressing of the “home” button in step S1506, the process advances to step S1509, and the Web browser 311 issues a display application switch request with designating the handle value of the copy 312 acquired in step S1502 (corresponding to step S1312).

### Screen Transition

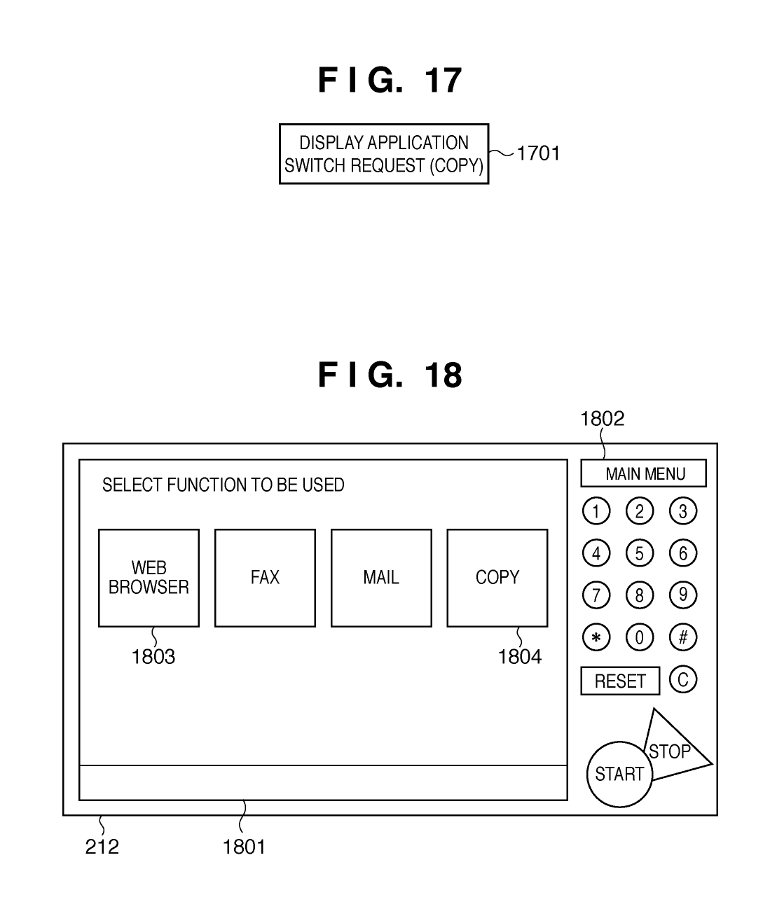

Screen transitions according to this embodiment will be described below with reference to FIGS. 16 and 17. When the user presses a main menu button 1802 on a copy screen 1601, the copy screen 1601 transits to the main menu screen 1801. When the user presses a Web browser button 1803 on the main menu screen 1801, the main menu screen 1801 transits to a Web browser screen 1602 to display Web page 1. In this state, a selection candidate of the “home” button is configured, as shown in FIG. 17. When the user presses a “home” button 1652, such pressing operation notifies the window manager 309 of a window switch request to the main menu screen 1801, thus allowing to return to the copy screen 1601. In this case, for example, when the selection candidate is the Web browser screen, the Web browser 311 displays an operation screen held by itself on the display unit without notifying the window manager 309 of a window switch request.

When the user presses a link (not shown) to Web page 2, which is included in Web page 1, the Web browser screen 1602 transits to a Web browser screen 1603 to display Web page 2. Even in this state, the selection candidate of the “home” button is configured, as shown in FIG. 17. When the user presses the “home” button 1653, a window switch instruction 1701 to the copy screen 1601 is read out, thus allowing to return to the copy screen 1601.

As described above, the image processing apparatus according to this embodiment further includes the following arrangement in addition to the arrangement of the first embodiment. More specifically, the Web browser 311 displays an operation screen of an external application including a “home” button used to allow a transition to a basic screen of the image processing apparatus. Furthermore, when the user presses the “home” button, the Web browser 311 notifies the window manager 309 of a screen switch request required to display the basic screen on the display unit. Thus, this image processing apparatus allows a transition from the screen of the Web browser to an operation screen of a native application as the basic screen of the image processing apparatus in response to an operation on the Web browser. Hence, this image processing apparatus can provide integrated operability between the external and native applications, thus improving user usability. This image processing apparatus allows the user to set the basic screen of the image processing apparatus from operation screens of the external and native applications. In this case, it is desired that when the user presses the “home” button, the Web browser 311 notifies the window manager 309 of a screen switch request required to display the basic screen on the display unit only when the operation screen of the native application is selected as the basic screen.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-139944 filed on Jun. 18, 2010, which is hereby incorporated by reference herein in its entirety.

What is claimed is:

1. An image processing apparatus, which allows for the use of an external application held in an external apparatus and an internal application held in a self apparatus, said apparatus comprising:
a screen management unit that switches an operation screen to be displayed on a display unit according to a screen switch request; and
a control unit that displays an operation screen of the external application on the display unit together with a first button used to allow a transition to an operation screen previously displayed on the display unit,
said control unit comprising:
a history management unit that manages history information indicating a display history on the display unit since an operation screen of the internal application which was displayed on the display unit before that operation screen was switched to an operation screen of the external application by said screen management unit;
a determination unit that determines, when the first button is pressed, with reference to the history information managed by said history management unit whether or not a transition destination of the operation screen is the operation screen of the internal application; and
a notification unit that notifies, when said determination unit determines that the transition destination is the operation screen of the internal application, said screen management unit of the screen switch request required to display the operation screen of the internal application on the display unit.

2. The apparatus according to claim 1, wherein when the operation screen of the internal application is switched to the operation screen of the external application, said history management unit acquires unique information indicating the internal application from said screen management unit, and manages, using the acquired unique information, the history information of the operation screen of the internal application displayed on the display unit before that operation screen was switched to the operation screen of the external application by said screen management unit, and
said notification unit notifies said screen management unit of the screen switch request with designating the acquired unique information.

3. The apparatus according to claim 1, wherein when said determination unit determines that the transition destination is not the operation screen of the internal application, said control unit displays, on the display unit, the operation screen of the external application which was previously displayed on the display unit, according to the history information.

4. The apparatus according to claim 3, wherein said history management unit deletes the history information of the operation screen displayed on the display unit by said control unit in response to pressing of the first button.

5. The apparatus according to claim 1, wherein said control unit displays an operation screen of the external application including a second button required to allow a transition to a basic screen of said image processing apparatus in addition to the first button, and
when the second button is pressed, said notification unit notifies the screen management unit of the screen switch request required to display the basic screen on the display unit.

6. The apparatus according to claim 5, further comprising a selection unit that selects an operation screen to be set as the basic screen from the operation screens of the external application and the internal application,
wherein when the second button is pressed, said notification unit notifies said screen management unit of the screen switch request required to display the basic screen on the display unit when the basic screen is the operation screen of the internal application.

7. A control method of an image processing apparatus, which allows the use of an external application held in an external apparatus and an internal application held in a self apparatus, and comprises
a screen management unit that switches an operation screen to be displayed on a display unit according to a screen switch request, and a control unit that displays an operation screen of the external application on the display unit together with a first button used to allow a transition to an operation screen previously displayed on the display unit,
the control unit executing:
controlling a history management unit to manage history information indicating a display history on the display unit since an operation screen of the internal application which was displayed on the display unit before that operation screen was switched to an operation screen of the external application by the screen management unit;
controlling a determination unit to determine, when the first button is pressed, with reference to the history information managed in the controlling the history management unit whether or not a transition destination of the operation screen is the operation screen of the internal application; and
controlling a notification unit to notify, when it is determined in the controlling the determination unit that the transition destination is the operation screen of the internal application, the screen management unit of the screen switch request required to display the operation screen of the internal application on the display unit.

8. A program for controlling a computer to execute a control method of an image processing apparatus according to claim 7.
